(19) United States
(12) Patent Application Publication
(10) Pub. No.: US 2021/0405646 A1
(43) Pub. Date: Dec. 30, 2021

(54) MARKER, METHOD OF MOVING IN MARKER FOLLOWING MODE, AND CART-ROBOT IMPLEMENTING METHOD

(71) Applicant: LG ELECTRONICS INC., Seoul (KR)

(72) Inventor: Hyeri PARK, Seoul (KR)

(73) Assignee: LG ELECTRONICS INC., Seoul (KR)

(21) Appl. No.: 16/765,089

(22) PCT Filed: Jul. 3, 2019
(86) PCT No.: PCT/KR2019/008176

§ 371 Date: May 18, 2020

(51) Int. Cl. G05D 1/02; G05D 1/00

(52) U.S. Cl. CPC G05D 1/0234; G05D 1/0238; G05D 1/0246; G05D 2201/0216; G05D 1/0225; G05D 1/0088; G05D 1/0223

(57) ABSTRACT

The present disclosure relates to a marker, a method for moving a cart-robot in a marker following mode, and a cart-robot that implements such method, and according to an embodiment of the present disclosure, the cart-robot that moves in the marker following mode includes a camera sensor that photographs the marker disposed on a travelling surface of the cart-robot or a side surface or the travelling surface or the ceiling of the travelling surface and a controller that analyzes an image photographed by the camera sensor, calculates a moving direction or a moving speed of the cart-robot that moves along the marker or a path where a plurality of markers are disposed by analyzing the image photographed by the camera sensor and controls a mover to move the cart-robot into a space indicated by the marker.

### TECHNICAL FIELD

The present disclosure relates to a marker, a method for moving a cart-robot in a marker following mode, and a cart-robot implementing such method.

### BACKGROUND ART

In spaces where human resources and material resources are actively exchanged such as large-scale marts, department stores, airports, and golf courses, various kinds of people may move with various types of objects carried. In this case, devices such as carts may assist users in moving objects, to provide the user with convenience.

In related art, the user may directly move the cart. However, the cart may interfere with the passage of other carts in the space during checking or paying for products, for example, various types of items. In this situation, it may take a long time for the user to control the cart and a lot of effects may be required to control, by the user, the cart.

Accordingly, in order for the user to move freely and perform various types of activities, the cart may move based on properties of the space without additionally controlling, by users, apparatuses such as carts or may move based on electric energy under control of the users.

In particular, a method of autonomously travelling cart-robots during using, by users, carts in a parking lot, and subsequently, returning the carts back to a particular position is described.

### DISCLOSURE

### Technical Problem

The present disclosure provides a method of automatically returning, when use of a cart-robot is finished, a cart-robot to a return place to improve user convenience.

The present disclosure provides a method of disposing markers to support autonomous movement of the cart-robot and moving the cart-robot while following the markers.

The present disclosure provides a method of following, by a cart-robot, markers by avoiding obstacles placed in a space where the cart-robot automatically moves and of automatically charging the cart-robot.

The objects of the present disclosure are not limited to the above-mentioned objects, and other objects and advantages of the present disclosure which are not mentioned above may be understood by the following description, and will be more clearly understood by the embodiments of the present disclosure. It will also be readily apparent that the objects and advantages of the present disclosure may be implemented by features described in claims and a combination thereof.

### Technical Solution

According to an embodiment of the present disclosure, a cart-robot of moving in a marker following mode may include a camera sensor that photographs a marker disposed on a travelling surface of the cart-robot or a side surface of the travelling surface or the ceiling of the travelling surface, and a controller that analyzes an image photographed by the camera sensor and calculates a moving direction or a moving speed of the cart-robot that moves along the marker or a path where a plurality of markers are disposed and control a mover to move the cart-robot into a space indicated by the marker.

According to an embodiment of the present disclosure, a controller of the cart-robot of moving in the marker following mode may determine a state in which an object is removed from a storage of the cart-robot or a state in which use of a transmission module followed by the cart-robot is finished or a handle assembly of the cart-robot may not sense a force during a predetermined period of time and the controller controls the camera sensor and the mover to search for the marker adjacent to the cart-robot, and the controller may controls the mover to move the cart-robot along markers adjacent to the cart-robot.

According to an embodiment of the present disclosure, a controller may stop, when an obstacle sensor of the cart-robot moving in the marker following mode detects an obstacle in the moving direction of the cart-robot, the cart-robot or may generate a bypass path to connect two markers disconnected due to the obstacle to move the cart-robot.

According to an embodiment of the present disclosure, the marker may include at least one light source that emit light, a communicator that receives, from a server, a control message to control operation of the marker, and a mark controller that controls light emitted by each of light sources in response to the control message.

According to an embodiment of the present disclosure, a method for moving a cart-robot in a marker following mode may include moving, by a mover of the cart-robot, the cart-robot, photographing, by a camera sensor of the cart-robot, a marker disposed on a travelling surface of the cart-robot or a side surface of the travelling surface, or the ceiling of the travelling surface during moving of the cart-robot, analyzing an image photographed by the camera sensor and identifying, by a controller of the cart-robot, the marker, calculating, by the controller, a moving direction or a moving speed of the cart-robot that moves along the identified marker or a path where the plurality of markers are disposed, and controlling, by the controller of the cart-robot, the mover to move the cart-robot into a space indicated by the markers based on at least one of the calculated moving direction or moving speed of the cart-robot.

According to an embodiment of the present disclosure, the method for moving the cart-robot in the marker following mode may include monitoring a state in which a plurality of cart-robots and obstacles are disposed to generate a marker control message, transmitting, by the server, a marker control message to the marker, activating or deactivating a light source of the mark in response to the mark control message, determining, by the cart-robot that moves while following the markers, an activated state or an deactivated state of the marker to move the cart-robot.

### Advantageous Effects

When embodiments of the present disclosure are applied, a cart-robot may move to a return place or a charging station through autonomous travelling when use of the cart-robot is required to be ended or the cart-robot is required to be charged.

When embodiments of the present disclosure are applied, the cart-robot may move while following markers and may autonomously travel without adjustment or control of users in this process.

When embodiments of the present disclosure are applied, the cart-robot may follow the marker and may move while avoiding obstacles placed in a travel section during autonomous movement of the cart-robot and may be automatically charged.

The effects of the present disclosure are not limited to the above effects, and those skilled in the art may easily understand various effects of the present disclosure based on configurations of the present disclosure.

### DESCRIPTION OF DRAWINGS

FIG. 1 shows exemplary appearance of a cart-robot.

FIG. 2 shows exemplary components of a control module of a cart-robot.

FIGS. 3 and 4 respectively show an exemplary process in which a cart-robot identifies a marker and moves at a point where use of the cart-robot, by users, is finished, such as a parking lot.

FIGS. 5 and 6 respectively show an exemplary process in which a cart-robot identifies a marker and moves toward a charging station to charge the cart-robot when the cart-robot is required to be charged.

FIG. 7 shows exemplary movement of a cart-robot in a charging station.

FIG. 8 shows an exemplary process of returning a cart-robot to a storage place in detail.

FIG. 9 shows an exemplary marker disposed in a parking lot or a mart, and interaction between a server that controls such marker and a cart-robot.

FIG. 10 shows an exemplary process of activating markers based on arrangement of obstacles.

FIGS. 11 and 12 respectively show an exemplary process of changing, by a cart-robot, a path, when an obstacle is disposed above a marker.

FIG. 13 shows an exemplary process in which a cart-robot generates a shortest path based on a marker.

FIG. 14 shows an exemplary configuration of a marker.

FIG. 15 shows an exemplary configuration of an AI server.

### DETAILED DESCRIPTIONS

Hereinafter, embodiments of the present disclosure will be described in detail with reference to the accompanying drawings so that those of ordinary skill in the art can easily implement the embodiments. The present disclosure may be embodied in many different manners and is not limited to the embodiments set forth herein.

Parts irrelevant to description are omitted in the drawings in order to clearly explain the present disclosure. A same reference numeral is allocated to same or similar components throughout the present disclosure. In addition, some embodiments of the present disclosure will be described in detail with reference to example drawings. In the following description, like reference numerals designate like elements although they are shown in different drawings. In the following description of the present disclosure, detailed descriptions of known components and functions incorporated herein will be omitted in the case that the subject matter of the present disclosure may be rendered unclear thereby.

In describing components of the present disclosure, there may be terms used such as first, second, A, B, (a), and (b). Such terms are merely used to distinguish one component from another component. The nature, sequence, order, or number of these components is not limited by these terms. When a component is referred to as being “coupled” or “connected” to another component, it should be understood that the component is coupled or connected directly to another component or an additional component is “interposed” therebetween or the two components may be “coupled” or “connected” to each other with an additional component interposed therebetween.

Further, with respect to implementation of the present disclosure, for convenience of description, components will be described by being subdivided. However, these components may be implemented within a device or a module, or a component may be implemented by being divided into a plurality of devices or modules.

Hereinafter, devices that autonomously move while following a user or move based on electrical energy under control of a user are referred to as “a smart cart-robot”, “a cart robot”, “robot” or “a cart” for short. The cart robot may be used in stores, for example, large marts or department stores. Alternatively, the cart-robot may be used, by users, in spaces such as airports or harbors in which many travelers move. The cart-robot may also be used in leisure spaces such as golf courses.

In addition, the cart-robot includes all devices which track a position of a user to follow the user and have a certain storage space. The cart-robot includes all devices that move based on electric power under control of the user pushing or pulling the cart-robot. As a result, the user may move the cart robot without operating the cart-robot. In addition, the user may move the cart-robot with a very small magnitude of force.

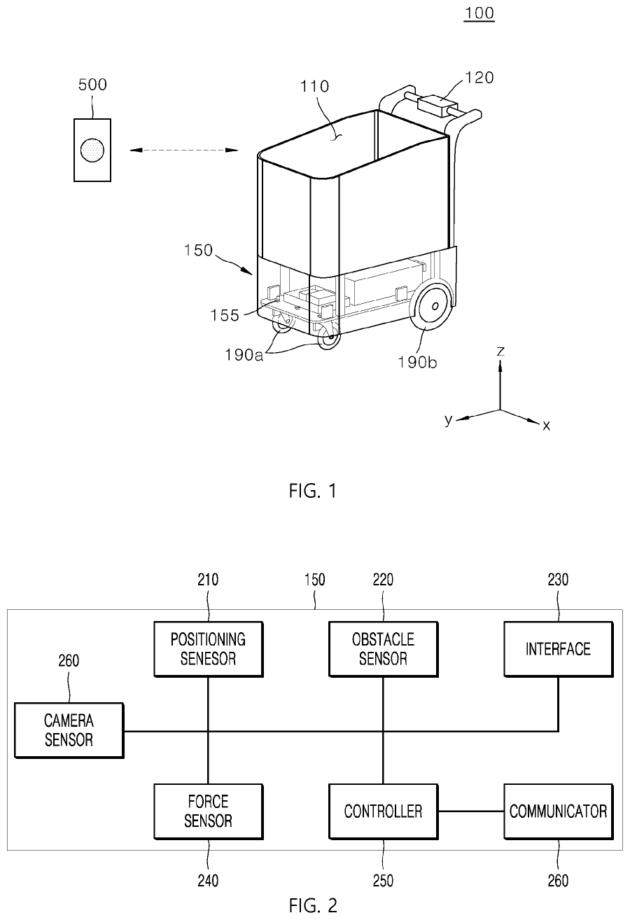

FIG. 1 shows exemplary appearance of a cart-robot. FIG. 2 is exemplary components of a control module 150 of a cart-robot.

A cart-robot 100 includes a storage 110, a handle assembly 120, a control module 150, and movers 190a and 190b. An object is stored or loaded, by the user, in the storage 110. The handle assembly 120 enables a user to manually control the movement of the cart-robot 100 or to semi-automatically control the movement of the cart-robot 100.

Using the handle assembly 120, the user may push the cart-robot 100 forward or rearward or may change a direction of the cart-robot 100. In this case, based on a magnitude of the force applied to the handle assembly 120 or a difference between the magnitude of leftward force and the magnitude of rightward force, the cart-robot 100 may travel semi-automatically based on the electrical energy.

The control module 150 controls the movement of the cart-robot 100. In particular, the control module 150 controls the autonomous travelling of the cart-robot 100 so that the cart-robot 100 follows the user. Further, the control module 150 controls the semi-autonomous travelling (a power assist) of the cart-robot by assisting the user's power to push or pull the cart-robot, by the user, with a less magnitude of force.

The control module 150 may control the mover 190. The mover 190 moves the cart-robot along a moving path generated by a controller 250. The mover 190 may move the cart-robot by rotating wheels included in the mover 190. The controller 250 may identify the position of the cart-robot 100 based on a rotating speed and a number of rotations, and a direction, of the wheel, through the movement of the cart-robot by the mover 190. An angular speed applied to a left wheel and a right wheel of the cart-robot is provided, in the moving path generated by the controller 250.

Further, positioning sensors may be disposed in many areas of the cart-robot 100 to track the position of the user to follow the user. Further, obstacle sensors may be disposed in many areas of the cart-robot 100 to detect an obstacle around the cart-robot 100. The positioning sensor may detect a transmission module 500 that outputs a particular signal.

Configurations are described with reference to FIG. 2.

FIG. 2 shows a positioning sensor 210, a force sensor 240, an obstacle sensor 220, an interface 230, a controller 250, a camera sensor 260, and a communicator 280, which are logical components included in a control module 150.

The obstacle sensor 220 senses an obstacle provided near the cart-robot. The obstacle sensor 220 may sense a distance between the cart-robot and a person, a wall, an object, a fixed object, an installed object, and the like.

The positioning sensor 210 is required for the cart-robot that supports autonomous traveling. However, in a cart-robot that supports only semi-autonomous traveling (power assist), the positioning sensor 210 may be selectively disposed.

The positioning sensor 210 may track the position of the user who carries the transmission module 500 and may be disposed at an upper end or a side surface of the cart-robot 100. However, positions of sensors can be changed in various manners and the present disclosure is not limited thereto. Regardless of positions of sensors, the controller 150 controls sensors or use information sensed by sensors. That is, sensors are logical components of the controller 150 regardless of physical positions of sensors.

The positioning sensor 210 receives a signal from the transmission module 500 and measures a position of the transmission module 500. When the positioning sensor 210 uses an ultra-wideband (UWB), a user may carry the transmission module 500 that transmits a certain signal to the positioning sensor 210. The positioning sensor 210 may identify the position of the user based on the position of the transmission module 500. In an embodiment, the user may carry the transmission module 500 in the form of a band attached to his or her wrist.

In addition, an interface may be disposed in the handle assembly 120 to output certain information to the user. The interface may also become a component controlled by the control module 150. The handle assembly 120 includes the force sensor 240 which senses a force with which the user pushes or pulls the cart robot.

The force sensor 240 may be disposed outside or inside the cart robot 100 to which a change in force is applied by operation of the handle assembly 120. The position and configuration of the force sensor 240 may be variously applied, and embodiments of the present disclosure are not limited to the specific force sensor 240.

The force sensor 240 is disposed in the handle assembly 120 or disposed outside or inside the cart robot 100 connected to the handle assembly 120. When the user applies a force to the handle assembly 120, the force sensor 240 senses a magnitude of the force or a change in the force, and the like. The force sensor 240 includes various types of sensors such as a Hall sensor, a magnetic type sensor, and a button type sensor. The force sensors 240 may include a left force sensor and a right force sensor and may be disposed in the handle assembly 120 or inside or outside the cart robot 100.

The obstacle sensor 220 senses obstacles disposed around the cart-robot. The obstacle sensor includes a sensor that measures a distance or acquires an image and identifies an obstacle in the image. In an embodiment, examples of the obstacle sensor 220 configured to measure a distance may include an infrared sensor, an ultrasonic sensor, a LiDAR sensor, and the like.

In addition, the obstacle sensor 220 includes a depth sensor or a red-green-blue (RGB) sensor. The RGB sensor may sense an obstacle and an installed object in an image. The depth sensor generates depth information for each point in an image. Further, the obstacle sensor 220 includes a time-of-flight (ToF) sensor.

The controller 250 cumulatively stores position information related to a transmission module and generates a moving path corresponding to the stored position information related to the transmission module. In order to cumulatively store the position information, the controller 250 may store the position information related to the transmission module 500 and the cart-robot 100 as information on absolute position (absolute coordinates) based on a predetermined reference point.

Further, the controller 250 may control the movement of the cart-robot using the obstacle sensor 220 and the camera sensor 260. In particular, the controller 250 may analyze the image photographed by the camera sensor 260 and may calculate the moving direction or the moving speed of the cart-robot 100 that moves along markers, to move the mover 190.

Further, the controller 250 controls the moving direction or the moving speed of the mover based on changes or a magnitude of the force sensed by the force sensor 240. Alternatively, the controller 250 may control the mover 190 so that a large amount of electric energy is provided to a motor of the mover to control the moving speed of the mover.

Further, the controller 250 detects an installation disposed around the cart-robot based on a value sensed by the obstacle sensor 220. The controller 250 may check the installation using the obstacle sensors 220 disposed on the side surface and the front surface of the cart-robot.

That is, the controller 250 analyzes the image photographed by the camera sensor 260 and calculates the moving direction or moving speed of the cart-robot that moves along the marker or a path where the plurality of markers are disposed and controls the mover 190 to move the cart-robot into a space indicated by a marker. The space indicated by the marker refers to a space where arrangement of the marker is finished or a space where a marker having a particular shape is disposed to stop the movement of the cart-robot.

In an embodiment of the parking lot, the space may be indicated by the markers, the cart-robots use of which is finished are aligned in the space. In embodiments of the store or the parking lot, a space where the cart-robots may charge may be indicated by markers. Based on a result of indicating, by the markers, a particular space, the cart-robot may determine shapes of the markers and may move along the marker so that the cart-robot arrives at the particular space.

The controller 250 may control the cart-robot to move along the marker. Alternatively, when the marker is covered by an obstacle and two or more spaced markers are detected, the controller 250 generates a bypass path between the two spaced markers to temporarily move the cart-robot away from the marker to avoid the obstacle, and then move the cart-robot 100 along the marker again.

Alternatively, when a plurality of markers are identified or no obstacles are present, the controller 250 may generate a shortest path between the markers and may move along the shortest path between the markers.

The camera sensor 260 may photograph an image of an object/person/installation around the cart-robot. In particular, in the present disclosure, the camera sensor 260 may photograph a marker disposed on the floor in the space where cart-robot 100 travels, that is, a travelling surface. Further, the camera sensor 260 may photograph the marker disposed on the side surface of the travelling surface. The camera sensor 260 may be disposed at a lower end or a side or a front portion of the cart-robot 100.

In another embodiment, the camera sensor 260 may photograph marker disposed on the ceiling. In this case, the camera sensor 260 may be disposed on the handle assembly or the storage 110 of the cart-robot 100.

That is, the obstacle sensor 220 or the camera sensor 260 may be disposed at various positions such as a lower end, the middle, or a side of the cart-robot 100 to sense or photograph objects in various directions.

For example, a plurality of obstacle sensors 220 may be disposed in an area indicated by reference numeral 155 to sense obstacles provided at a front side/a left side/a right side/a rear side of the cart-robot. The obstacle sensor 220 may be disposed at the lower end of the cart-robot and may have the same height. Alternatively, the obstacle sensor 220 may be disposed at the lower end of the cart-robot 100 in two or more areas having different heights.

Further, the obstacle sensor may be disposed on or at a front surface/both sides of the cart-robot 100 and may be disposed in a moving direction of the cart-robot 100. Alternatively, when the cart-robot 100 moves rearward, obstacle sensors may be disposed on the front surface, the rear surface, and at both sides of the cart-robot 100.

Similarly, the camera sensor 260 may also be disposed at various positions where the obstacle sensors 200 are disposed to acquire the image. For example, when the camera sensor 260 captures front image information, the camera sensor 260 may be disposed in front of the cart-robot 100. Alternatively, when the camera sensor 260 captures rear image information, the camera sensor 260 may be disposed at a lower portion of the cart-robot 100.

Meanwhile, after controlling, by the user, the cart-robot 100 is finished or when capacity of the battery of the cart-robot 100 is insufficient, the cart-robot 100 is required to be moved to a particular area. In this process, the cart-robot 100 may sense a marker to determine the space during autonomously moving of the cart-robot 100 to the particular area of the parking lot or a charging space.

That is, when the user no longer controls the cart, the cart-robot 100 may move to the particular space and enter a standby mode or a charging mode so that other users use the cart-robot 100. To this end, the cart-robot 100 may identify the marker disposed in the space.

For example, when the use of cart-robot moved to the parking lot is finished, the cart-robot may move to a particular standby place in an autonomous travelling mode. Alternatively, the cart-robot the user of which is finished may move to the charging place in the autonomous travelling mode.

In such an embodiment, the cart-robot 100 may determine a target point to which the cart robot 100 moves or may have a plurality of candidate target points. In this situation, the cart-robot 100 is required to identify information, such as a marker, to move to a target point more accurately, quickly and safely.

In this process, the camera sensor 260 identifies the marker and the controller 250 of the cart-robot 100 is required to perform the rapid determination with respect to a path along which the cart-robot 100 autonomously travels, a direction, and a speed of the cart-robot 100. For example, according to the present disclosure, when a plurality of cart-robot are disposed in the parking lot while avoiding the vehicle and person at the same time, in the parking lot, a technology for assisting safe movement of the cart-robot 100 may be proposed using the camera sensor 260 of the cart-robot 100.

Meanwhile, the controller 250 of the cart-robot 100 may additionally have artificial intelligence module. When the information sensed by the obstacle sensor 220 or captured by the camera sensor 250 is provided to the controller 250, the artificial intelligence module in the controller 250 receives the information and may determine whether the cart-robot 100 enters a particular space. In one embodiment, the artificial intelligence module may perform machine learning or use deep learning network.

The controller 250 of the cart-robot may perform context awareness using the artificial intelligence module. Similarly, the controller 250 may determine the situation of the cart-robot 100 using the sensed values, the control of the user, or information received from other cart-robots or the server, as input values of the artificial intelligence module.

In particular, the cart-robot 100 may input, to the artificial intelligence module of the controller 250, various kinds of data generated in the state to control the speed or the direction of the cart-robot 100 during moving of the cart-robot 100 along markers in the particular space, for example, the parking lot, therby generating a result of determination.

Further, the controller 250 of the cart-robot may read the input image information using the artificial intelligence module. Further, the controller 250 may perform image processing. That is, the mark may be determined based on the input image.

The above-mentioned artificial intelligence module may include an inference engine, a neural network, and a probability model. The artificial intelligence module may perform supervised learning or unsupervised learning based on various kinds of data.

Further, the artificial intelligence module may recognize voice of the user and may perform the natural language processing to extract the information from the voice of the user.

Further, the controller 250 of the cart-robot 100 performs a function for voice recognition and a text-to-speech (TTS).

Thus, in the present disclosure, an embodiment is described in which the cart-robot 100 recognizes the particular space where the movement of the robot stops and the cart-robot 100 automatically moves. To this end, the cart-robot 100 may recognize the markers disposed on the floor or the wall of the space.

In one embodiment, the marker may be or may include a light source that emits light having a particular color. Alternatively, in an embodiment, the marker includes a marking device having a fixed pattern. The cart-robot 100 may operate in the marker following mode to follow the marker.

The marker may have a form of a line, and may be or include the light source having an arrow shape or a circular shape. Further, the markers may have different colors, and additional patterns are provided in the marker, to determine the moving direction of the cart-robot 100, the stopping of the mark-robot 100 based on the marker, or properties of the space where the markers are disposed.

That is, the marker may have a form of a fixed mark, or may include one or more light sources that emit light.

The controller 250 may calculate a moving speed or a moving direction of the cart-robot 100 in the space where the marker is disposed based on any one of the color, shape, or flickering pattern of the marker.

When the cart-robot 100 moves to a parking lot or an exit of a store and no longer follows the user, or the user may not control the cart-robot 100, the cart-robot 100 moves to the particular space for use of the next user and may wait.

In the following detailed description, a process of recognizing the marker disposed on the travelling surface and moving the cart-robot is described. However, the present disclosure is not limited thereto and the cart-robot may move along the marker disposed on the side surface or the ceiling with the same mechanism.

Further, in the description of the present disclosure, when the marker is disposed on the floor, the obstacle may be overlapped with the marker. Further, when the marker is disposed on the travelling surface, the side surface, or the ceiling, the obstacle includes all types of obstacles disposed on the path in which the cart-robot moves along the marker.

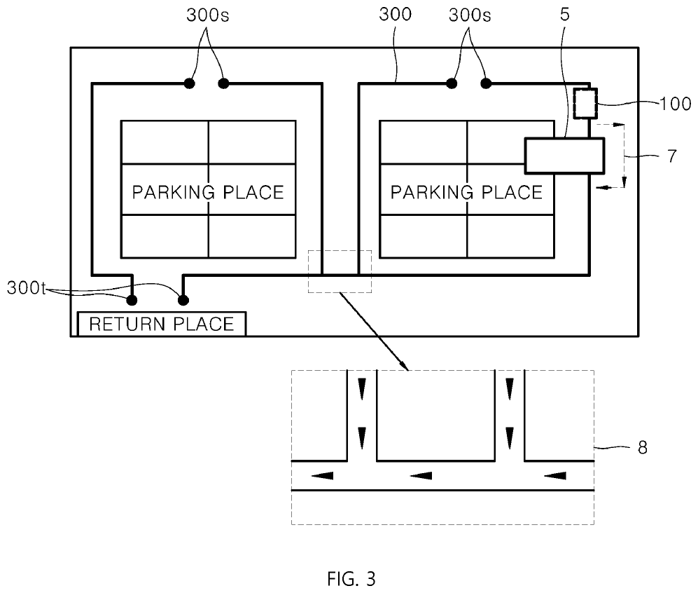

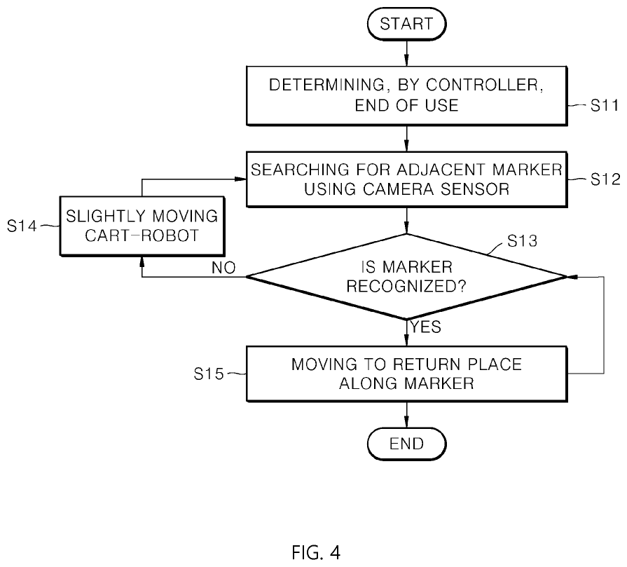

FIGS. 3 and 4 respectively show an exemplary process in which a cart-robot identifies a marker and moves from a point where use of the cart-robot, by the user, is finished, such as a parking lot.

FIG. 3 shows an exemplary marker 300 disposed to guide a cart-robot to automatically travel in a parting lot of a parking space or around the parking lot. In FIG. 3, based on the user who uses the cart-robot 100 disposing the cart-robot 100 adjacent to the parking space, and subsequently, use of the cart-robot 100 being finished, the cart-robot is changed to a marker following mode.

In the marker following mode, a camera sensor 260 disposed on a front surface, a side surface, or a lower surface of the cart-robot 100 recognizes the marker 300 having a line shape disposed nearby, and moves to a return place along the marker 300.

A stop marker 300t indicating a return place may be disposed near the return place of the cart-robot 100. The return place may be an entrance or an exit of the parking lot. Alternatively, the return place may be a place where the cart-robot may wait in the parking lot.

Reference numeral 300s corresponds to a marker disposed at a point where the user returns the cart-robot after the cart-robot is used. When the cart-robot 100 arrives at the reference numeral 300s and may not move for a predetermined period of time, the cart-robot 100 enters a marker following mode. The reference numeral 300s may be optionally arranged.

As described in reference numeral 8, when the marker 300 has a line form, arrows toward a return place may be disposed in the line. Alternatively, the mark itself may have an arrow shape and the cart-robot 100 may recognize it to detect a returning direction of the cart-robot 100.

In other words, a combination of the arrow-shaped marker indicating the direction with the line-shaped marker is also included in the embodiment of the present disclosure.

In another embodiment, the controller 250 may accumulate and store the moving paths of the robots after the cart-robot enters the parking lot and may determine the moving direction of the cart-robot 100 based on the adjacent markers.

FIG. 4 shows an exemplary process in which a cart-robot moves in a space as shown in FIG. 3.

A controller 250 determines that use of a cart-robot 100 is finished (S11). For example, the controller 250 determines, as the end of use of the cart-robot 100, a case in which a transmission module 500 is turned off or the end of use of the cart-robot 100 is notified, or a case in which the transmission module 500 is coupled into the cart-robot 100 and the transmission module 500 no longer moves.

Even when the transmission module 500 enters a storage in the cart-robot 100 or when the transmission module 500 is stored in a pre-appointed return place, the controller 250 determines the end of use of the cart-robot 100.

Further, the controller 250 determines that, as the end of the use of the cart-robot 100, the cart-robot may not move for a predetermined period of time or the objects stored in the storage 110 of the cart-robot 100 are all removed.

Further, the controller 250 determines that, as the end of the use of the cart-robot 100, a state in which a handle assembly 120 of the cart-robot may not sense the force during a predetermined period of time.

Alternatively, even when the cart-robot 100 moves to a particular point (e.g., a point at which the mark is disposed or a point at which the particular marker is disposed, along which the cart-robot returns) under the control of the user and may not move for a predetermined period of time, the controller 250 determines the end of use of the cart-robot 100.

Based on a result of determination that the use of the cart-robot 100 is finished, the controller 250 searches for a marker disposed adjacent to the cart-robot using the camera sensor 260 (S12). The controller 250 may control the camera sensor 260 and the mover 190 to search for the marker. For example, the controller 250 may search for the marker by turning the camera sensor 260 upward, downward, leftward, or rightward. Alternatively, the controller 250 slightly moves the cart-robot 100 to control the adjacent marker to be photographed by the camera sensor 260.

In this process, when the marker is recognized (S13), the controller 250 controls the cart-robot 100 to move to the return place along the adjacent markers (S15). Meanwhile, when the marker is not recognized in S13, the controller 250 slightly moves the cart-robot 100 (S14).

Meanwhile, during movement of the cart-robot 100, the controller 250 controls the camera sensor 260 to continually photograph the marker. The controller 250 determines the distance moved by the cart-robot 100 based on the photographed marker and the photographed position. Based on a determination that the end of use of the cart-robot 100 is determined, in S11, the controller 250 controls the cart-robot 100 to move to the marker, which is photographed as being closest to the cart-robot 100, and subsequently, controls the cart-robot 100 to move to a stop marker 300t indicating the return place along the marker.

Further, during moving of the cart-robot 100 in the parking lot as shown in FIG. 3, the controller 250 stops the cart-robot 100 based on the obstacle (person or a vehicle) being detected using the obstacle sensor 200. The controller 250 controls the cart-robot 100 to wait until the obstacle is not detected by the obstacle sensor 220. The controller controls the cart-robot 100 to move along the marker 300 again based on the obstacle being not detected.

Meanwhile, a situation may occur in which the vehicle is parked above the marker 300 or in a path along which the vehicle moves along markers or an obstacle may not move after the obstacle is detected. In this case, based on the obstacles not moving during a predetermined period of time (e.g., 1 minute), the cart-robot 100 may not follow the marker 300 but may move forward or rearward or leftward or rightward, and subsequently, may search for the marker 300 again.

For example, as shown in FIG. 3, when the vehicle 5 is incorrectly parked, the cart-robot 100 generates a bypass path represented by arrows indicated by reference numeral 7, with respect to a direction of the marker 300 tracked so far.

In examples in FIG. 3, when the cart-robot 100 moves from a store to a parking lot, the controller 250 may determine that the cart-robot enters the parking lot based on vibration occurring due to friction between the mover 190 and the travelling surface or changes in a frictional force of the travelling surface applied to the mover 190. Subsequently, based on a determination that the cart-robot enters the parking lot, the controller 250 may reset a control set, for example, a rotation of the mover 190 or a power of the motor, based on changed properties of the travelling surface.

Further, after entering the parking lot, the controller 250 activates the camera sensor 260 during moving of the cart-robot 100 to photograph the markers at predetermined time intervals. When the use of the cart-robot 100 is finished, information on markers previously photographed may be used to search for the adjacent marker.

The process in FIG. 4 is summarized as follows.

During moving of a cart-robot by a mover 190 of the cart-robot, a camera sensor 260 of the cart-robot photographs a marker disposed on a travelling surface or a side surface or the ceiling of the travelling surface of the cart-robot. The controller 250 identifies the marker by analyzing the image photographed by the camera sensor 260.

The controller 250 calculates a moving direction or a moving speed of the cart-robot corresponding to the indentified marker or path between multiple markers. In this process, the controller 250 may generate the bypass path or a shortest path.

The controller 250 controls the mover based on at least one of the calculated moving direction or moving speed of the cart-robot 100 to move the cart-robot into the space indicated by the marker. In one embodiment, the space indicated by the marker refers to a space into which the cart-robot returns after the cart-robot is used or a charging space.

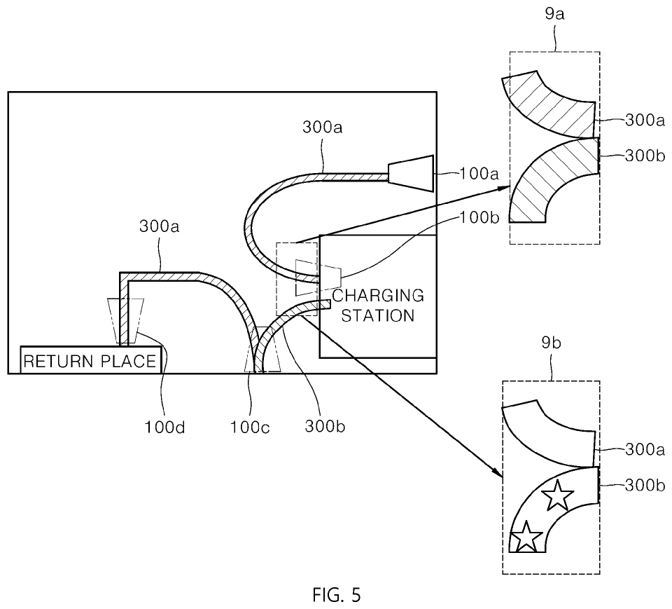

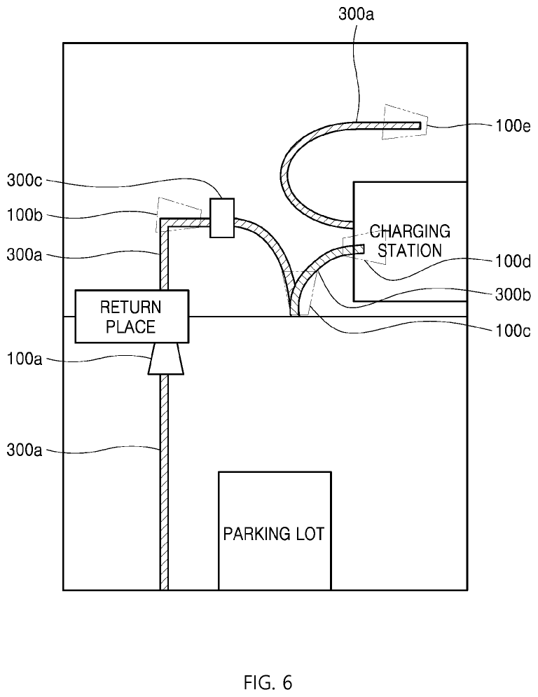

FIGS. 5 and 6 respectively show an exemplary process in which a cart-robot identifies a marker and moves toward a charging station to charge the cart-robot when the cart-robot is required to be charged.

In FIG. 5, a cart-robot 100a moves along a marker 300a indicating straight movement to a point at which a charging station is disposed. A cart-robot 100b moves rearward along a rearward marker 300b after charging is performed at a charging station. Subsequently, a cart-robot 100c arrives at a return place along the marker 300a indicating the straight movement back to the return place. Upon arrival, a cart-robot 100d stops at a storage station of the return place and waits for the next use.

In the process in FIG. 5, the cart-robots 100a to 100d move along the markers 300a and 300b through autonomous travelling. The cart-robot 100b may straightly move to the charging station and performs docking with the charging station to charge the cart-robot 100. A marker 300a to move the cart-robot 100 forward and a marker 300b to move the cart-robot 100 rearward may be disposed around the charging station and the marker 300a and the marker 300b may have different shapes from each other. For example, the two markers 300a and 300b may have line forms and may have different colors from each other. Alternatively, an additional pattern is added into the marker, so that the mark 300a to move the cart-robot 100 forward and the marker 300b to move the cart-robot 100 rearward may have different shapes from each other.

For example, in reference numeral 9a, the markers have different colors and have different hatched patters, so that the cart 100a may distinguish the marker 300a and the marker 300b. Alternatively, in reference numeral 9b, the additional star-shaped pattern is disposed only in the rearward marker 300b, so that the cart 100a may distinguish the marker 300a and the marker 300b.

The cart-robot 100b moved along the marker 300a automatically docks with the charging station to perform the charging. When the charging of the cart-robot 100 is completed, the cart-robot 100b moves, from the charging station, to a point at which a cart-robot 100c is disposed along the marker 300b indicating the rearward movement, and subsequently, the cart-robot 100d returns back to a return place along the marker 300a indicating the forward movement.

At the charging station, the obstacle sensor 220 and the camera sensor 260 recognize other cart-robots disposed in front of the charging station, and other cart-robots are parked in a row.

The return place in FIG. 5 may be adjacent to or the same as the return place in FIG. 3. Configuration is described with reference to FIG. 6. As shown in FIG. 3, after the cart-robot moves from the parking lot to the return place, the cart-robot 100a moves from the return place to the charging station. However, as other cart-robots may be being charged at the charging station, the cart-robot 100b detects a standby marker 300c and stops. When other carts are being charged at the charging station, the cart-robot 100b waits for a charging sequence.

In particular, when the cart-robot 100a moves from the parking lot to an area (e.g., a store) having the charging station, the mover 190 of the cart-robot 100 may detect changes in a road surface. For example, a controller 250 determines changes in the floor surface based on rotation of wheels or power and a moving speed of the motor applied to the wheels.

Subsequently, the controller 250 resets the control set such as the rotation of the mover 190 or the power of the motor based on changed properties of the floor surface. Through resetting of the control set, control set with respect to the parking lot and the control set with respect to the store are separately stored, and subsequently, the controller 250 loads the control set in response to changes in the floor surface, to control the mover 190.

After the cart-robot 100b temporarily stops at a standby marker 300c indicating the standby, the camera sensor 260, the obstacle sensor 220, or the communicator 280 may determine whether other cart-robots are present in the charging station. Based on other cart-robots being present in the charging station, the cart-robot 100b stops and waits. As a result, currently charging cart-robots in the charging station may not collide with the standby cart-robot even when the cart-robot performs the rearward movement.

To this end, the standby marker 300c is spaced apart from the marker 300b indicating rearward movement, and the cart-robot 100b may identify the standby marker 300c and select the standby position before entering the charging station.

Based on other cart-robots not present in the charging station, the cart-robot 100b moves to a position at which the cart-robot 100d is disposed via a position at which the cart-robot 100c is disposed. The cart-robot 100d may move rearward along the marker 300b indicating the rearward movement, along a charging direction of the charging station to be coupled to the charging station.

Alternatively, as shown in an example in FIG. 5, when a front side of the cart-robot is coupled to the charging station, the cart-robot may straightly move along the marker indicated by reference numeral 300b.

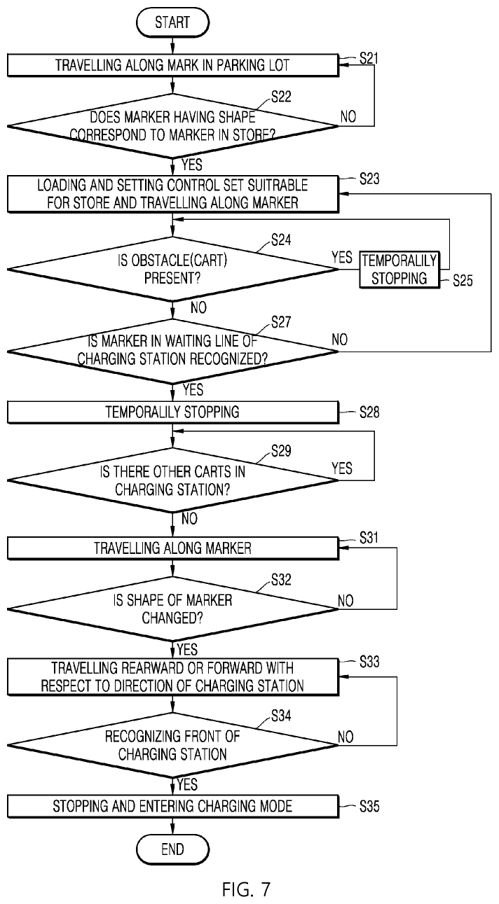

FIG. 7 shows an exemplary process of moving a cart-robot, with respect to a charging station. As shown in FIG. 6, a process of moving a cart-robot, which entered a return place from a parking lot is described below.

The cart-robot travels along a marker in the parking lot (S21). Further, a camera sensor 260 of the cart-robot photographs the marker, and a controller 250 analyzes the marker to determine that a shape of the marker is changed and the marker having the changed shape corresponds to the marker in a store (S22). Based on a determination that the photographed marker corresponds to the marker in the store, the cart-robot 100 enters the store. The controller 250 loads a control set of a mover to be suitable for the store and set it to the mover 190 and controls the cart-robot 100 to travel along the marker (S23).

The shape of the marker may differ in color, design, or pattern of the marker at the parking lot and the marker. Whether a space where the cart-robot 100 moves is a store or a parking lot may be determined based on photographing and analyzing the shape of the marker. In S22, if the marker corresponds to the marker of the parking lot, the cart-robot 100 may continually move along the marker toward the return place.

In one embodiment, a process of moving in the store in S23 moves along the marker as shown in FIGS. 5 and 6. During moving of the cart-robot, the cart-robot 100 detects whether an obstacle (or other cart-robots) is present around the cart-robot 100 using an obstacle sensor 220 (S24). The above-mentioned operation is performed through an obstacle avoiding method, to sense a distance between the cart-robot and an obstacle and avoid collision with the obstacle disposed in a moving direction of the cart-robot (a direction in which the marker is disposed). Based on the obstacle being detected (S24), the cart-robot 100 temporarily stops (S25) and waits until the obstacle moves to another point. If the standby time becomes longer, the controller 250 may temporarily deviate from the marker to move the cart-robot 100.

After the obstacle moves or when the obstacle is not detected, the cart-robot 100 determines whether a marker disposed in a waiting line of the charging station is recognized (S27). Based on the marker disposed in the waiting line of the charging station being not recognized, the cart-robot continually moves along the marker. Based on the marker disposed in the waiting line of the charging station being recognized, the cart-robot 100 temporarily stops (S28). After the temporal stop, the cart-robot 100 determines that other cart-robots are being charged at the charging station using the camera sensor 260, the obstacle sensor 220 or the communicator 280 (S29).

Based on a determination that other cart-robots are not present or the charging station is empty, the cart-robot 100 moves toward the charging station along the marker (S31). Based on other cart-robots being charged, the cart-robot maintains a stopped state and periodically performs a process in S29.

In a process in S31, the camera sensor 260 photographs the marker, and the controller 250 determines whether the shape of the marker is changed (S32). For example, as shown in FIG. 5 or 6, when the forward marker and the rearward marker are provided differently, the cart-robot 100 may change the moving direction of the cart-robot 100 based on changes in the marker. That is, when the shape of the marker is changed, as shown in FIG. 6, rearward or forward movement may be performed with respect to a direction of the charging station (S33). When the shape of the marker is not changed, the cart-robot 100 continually travels along the marker.

In a process in S33, the robot disposed in front of the charging station may be determined based on the information obtained by the camera sensor 260, the obstacle sensor 220 or the communicator 280. Based on a determination that the cart-robot is disposed in front of the charging station (S34), the cart-robot stops and enters a charging mode (S35). If not, the cart-robot 100 continually moves toward the charging station.

Meanwhile, when the cart-robot 100 may be charged in the charging station bidirectionally regardless of a forward direction or a rearward direction of the cart-robot 100, or when the cart-robot rotates in front of the charging station and moves without an additional rearward marker, the cart-robot may continually move to the charging station along the marker without determination that the shape of the marker is changed in S32.

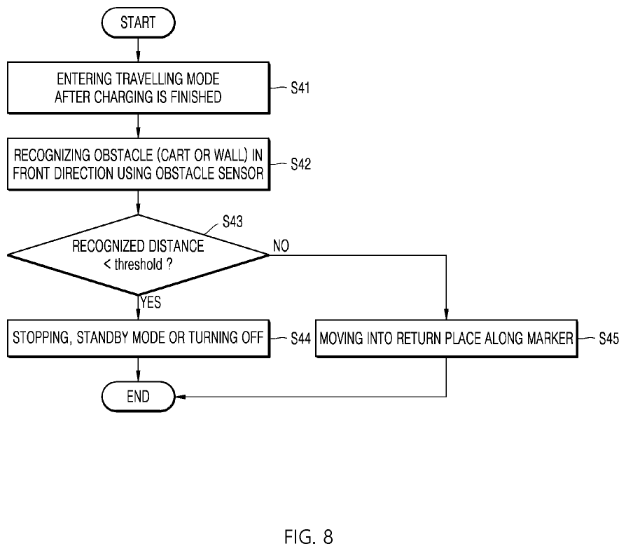

FIG. 8 shows an exemplary process of returning to a storage place in detail. After charging a cart-robot is completed, a cart-robot 100 completes a charging mode and enters a travelling mode (S41). An obstacle sensor 220 of the cart-robot 100 recognizes an obstacle (a person, an object, other cart-robots, a wall, and the like) in front of the cart-robot 100 (S42).

Based on a distance between the cart-robot 100 and the obstacle, for example, a distance recognized by the obstacle sensor 220 being less than a threshold (S43), the cart-robot 100 temporarily stops and enters a standby mode or is turned off to prevent collision with the obstacle (S44). After a predetermined period of time after the cart-robot is turned off, the cart-robot is turned on again to determine whether the obstacle is not present.

Meanwhile, based on the distance between the cart-robot and the obstacle being greater than the threshold in S43, the cart-robot 100 moves to the return place along the marker (S45). In this process, the obstacle sensor 220 may repeatedly detect the obstacle and may perform operation of stopping to avoid the detected obstacle (S44).

In summary of a process in FIG. 8, the cart-robot 100 travels along the marker when returning to the return place with a storage station after the charging of the cart-robot 100 is completed. In this case, the marker may have a form of a line. During returning, the distance between the cart-robot and the obstacle is sensed using the obstacle sensor 220. The cart-robot 100 recognizes other cart-robots disposed on the wall or at a front side of the cart-robot 100 and stops when the distance between the cart-robot 100 and the obstacle is less than a predetermined reference distance range.

During returning to the return place, the cart-robot recognizes other cart-robots disposed on the wall of the side surface or disposed on the side surface using the obstacle sensor 220 disposed on the side surface. Based on other cart-robots being not disposed in a moving direction of other cart-robots and not affecting the movement of the cart-robot that moves along the marker, the cart-robot may continually go straight.

Further, during entering of the cart-robot 100 the charging station, when there is the wall or the cart-robot on the side surface and the cart-robot 100 may not collide with another cart-robot while approaching to the charging station, the cart-robot may straightly move to connect to the charging station.

The above configuration is described as follows. The controller 250 monitors a charging state of the cart-robot and searches for the marker indicating the movement to the charging station using the camera sensor. Further, the controller 250 moves the cart-robot along the found marker.

That is, based on the camera sensor 260 photographing the standby marker 300c during moving of the cart-robot along the marker, the controller 250 stops the movement of the cart-robot. The controller 250 searches for other cart-robots being charged at the charging station or the obstacle disposed around the charging station using the obstacle sensor 220 or the camera sensor 260. Based on searching of other cart-robots or the obstacle, the cart-robot 100 may directly approach to the charging station or may wait for a quite time period.

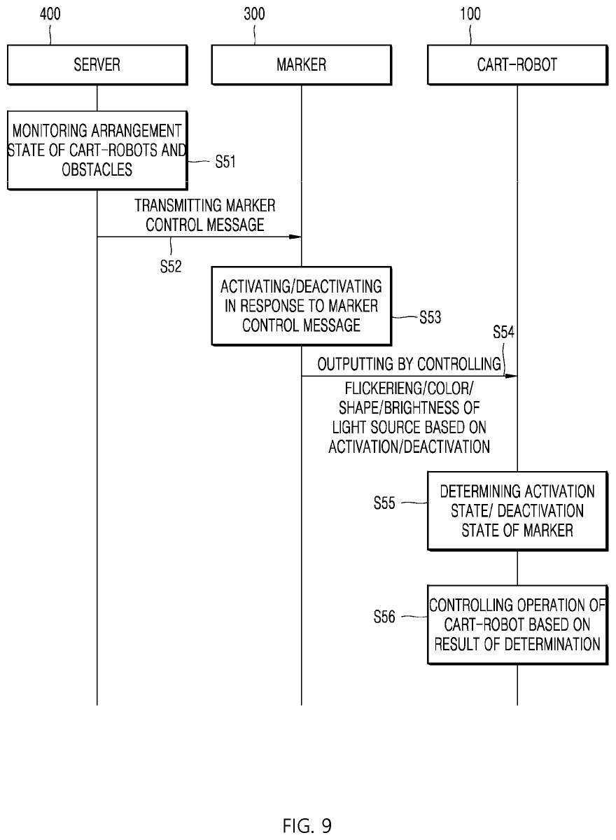

FIG. 9 shows an exemplary marker disposed in a parking lot or a mart and interaction between a server that control the marker and a cart-robot. In FIG. 3, the marker includes a light source that emits a light in various manners.

For example, when the marker includes a plurality of light sources, the color, a flickering pattern, and a shape of the marker is determined based on the color or a flickering speed of the light emitted by the light source, on-state/off-state of the light source. Thus, the controller 250 determines, as one piece of information, the color, the flickering pattern or the shape of the marker, to calculate the moving speed or the moving direction of the cart-robot in the space where the mark is disposed.

The server 400 monitors an arrangement state of the cart-robots and obstacles using various types of information collecting devices in the space where the cart-robots 100 operate (S51). Collecting devices that are fixed in each zone (cameras, CCTVs, signal detectors, and the like) collect a moving speed of the cart-robots or the number of disposed cart-robots, and a situation in which the obstacles are disposed around the marker. Alternatively, the collecting devices that receive information on a movement state of the cart-robots may include a marker 300.

The server 400 generates a control message to control markers based on a result of monitoring and transmits the control message to the markers (S52). For example, when markers have a line form and the vehicles are not disposed in a particular area of the parking lot, the server 400 may turn off a portion of markers and may turn on a portion of markers so that the cart-robot is returned to the return place rapidly, to thereby move the cart-robot along the markers to form a short path.

In addition to on-state/off-state of the light sources, the server 400 controls the color emitted by the marker or the flickering speed of the marker so that the cart-robot 100 may distinguish an activated marker from a the deactivated marker.

The server 400 determines a state in which the obstacles are distributed in the space where the markers are disposed, a state in which the cart-robot moves and an entering speed or a moving direction suitable for the cart-robots 100 may be determined based on the marker. For example, the server 400 may transmit, to the marker 300, a message to control the color of the light output by the marker and an on/off control message. Alternatively, the server 400 may transmit, to the marker, the message to control the flickering speed of the light output by the marker. The light sources may be differently disposed or brightness or a magnitude of the light source may be differenced based on a position of the marker 300.

The marker 300 operates in an activation state/a deactivation state in response to the received marker control message (S53). During operation, the marker 300 may flicker the light source or may control and output the particular color or may output the light a particular shape/brightness of which is controlled (S54).

The cart-robot 100 determines an operation state of the marker 300, in particular, the activation state/the deactivation state (S55). Based on a result of determination, the operation of the cart-robot is controlled (S56). For example, based on the marker 300 being disposed and being turned off, the cart-robot 100 searches for the turned-on marker 300 disposed around the cart-robot 100. Based on the activated marker 300 being identified by rotating the camera sensor 260 or moving the cart-robot 100 forward or rearward or leftward or rightward, a marker following mode is performed to move to the marker 300 and move the cart-robot while following the marker.

Further, the controller 250 may control the moving speed or the moving direction of the cart-robot 100 based on properties of the light output by the marker 300.

In one embodiment, an example of the activation or deactivation of the marker may include the activation or deactivation of the light sources included in the marker. Further, based on a plurality of light sources being turned on/off so that a marker has a particular shape, the server 400 may instruct a portion of light sources to be turned on/off in order for the marker to have a particular shape. For example, when light sources having the rod shape are disposed, particular light sources are only turned on so that the marker has an arrow shape.

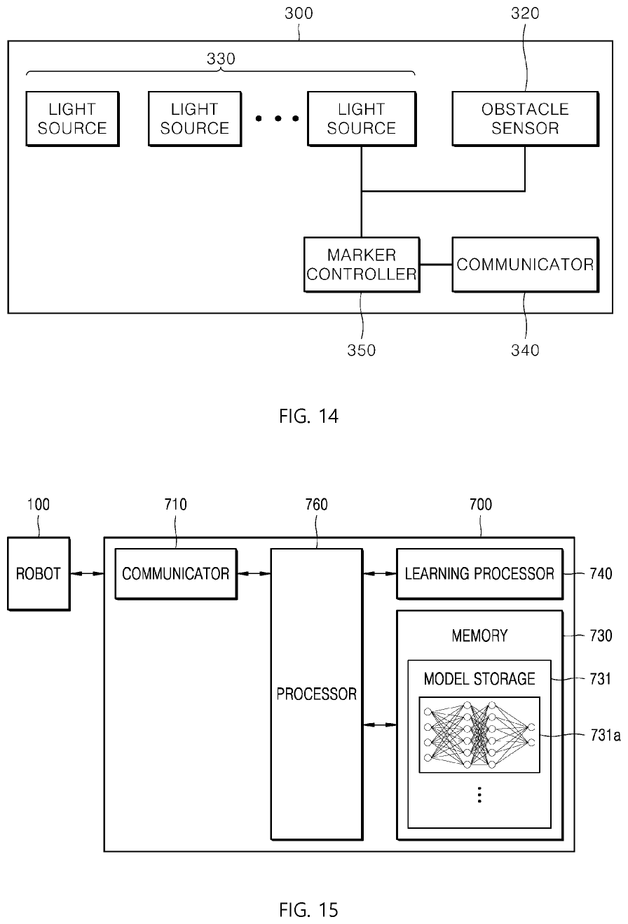

That is, the marker control message may be used to control the on-state or the off-state of one or more light sources included in the marker (FIG. 14). Further, the marker control message may include time information to maintain on-state/off-state of the light sources included in the marker.

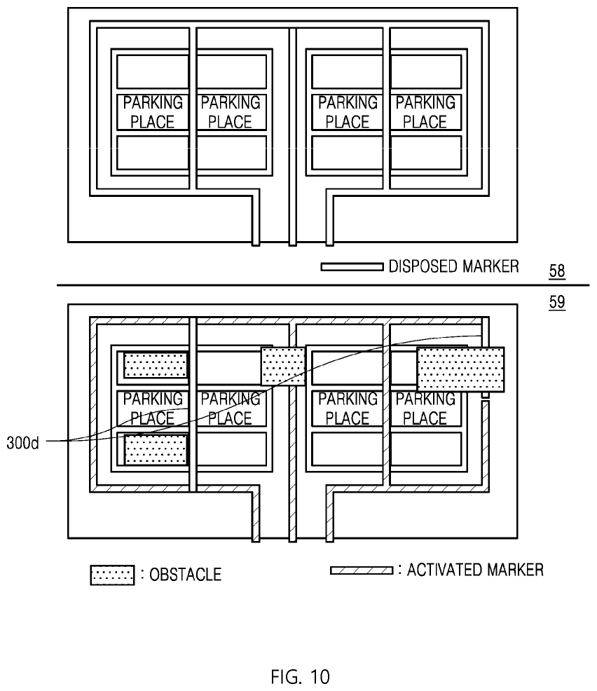

FIG. 10 shows an exemplary process of activating markers based on arrangement of obstacles.

Reference numeral 58 shows markers disposed in parking spaces. The markers may be turned on or off by a server 400. Therefore, as exemplified in reference numeral 59, when obstacles are disposed in some spaces, the marker indicated by reference numeral 300d, among disposed markers, maintains an off-state. Other markers maintain an on-state. As a result, a cart-robot 100 may move along markers that maintain the on-state.

As shown in FIG. 10, the marker includes a light source that emits light, and a controller 250 may calculate a moving speed or a moving direction of the cart-robot that moves along activated markers in a space where the markers are disposed, based on any one of the color or the shape or the flickering pattern (including the activation/the deactivation) of the marker.

In particular, the moving speed of the cart-robot 100 may vary based on the color of the marker. For example, based on the marker being blue color, the cart-robot 100 may increase the moving speed of the cart-robot 100, and based on the marker being red color, the cart-robot 100 may decrease the moving speed of the cart-robot 100. A server 400 may monitor a movement state of the obstacles around the marker or other cart-robots to control a shape, for example, the color or the flickering state of the markers, so that the cart-robots may move while following the marker in which a real-time state of the space is reflected.

Some of the markers may be selectively activated or deactivated to increase efficiency of autonomous travelling of the cart-robot 100 to follow the marker in a space where various types of obstacles such as a parking lot move (vehicle, person, and the like). In particular, under the control of the server 400, the marker disposed in the area having a lot of obstacles in the travelling space may be deactivated to avoid collision with the obstacle during returning of the cart-robot 100.

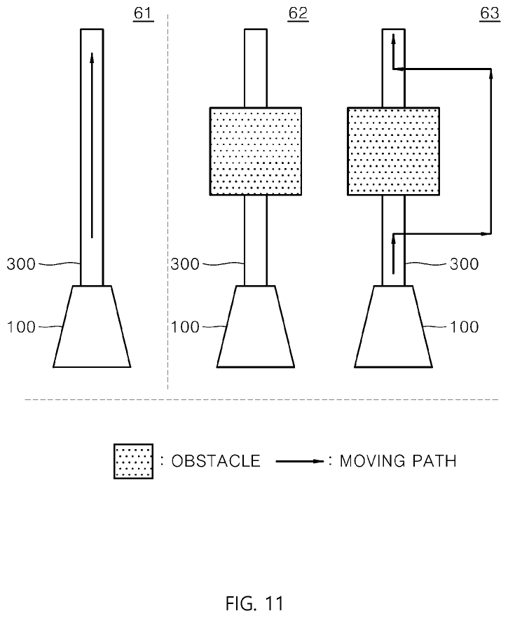

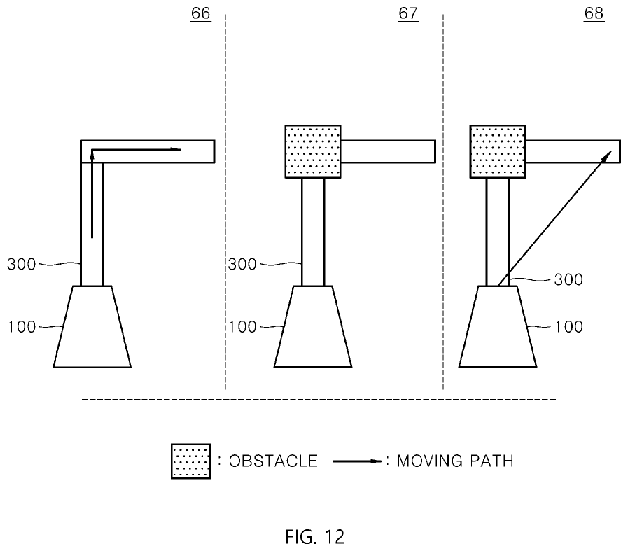

FIGS. 11 and 12 respectively show an exemplary process of changing a path by a cart-robot when obstacles are disposed above markers.

In FIG. 11, in reference numeral 61, a marker 300 is disposed and a path along which a cart-robot 100 moves is indicated by an arrow. As shown in reference numeral 61, based on an obstacle being not present, the cart-robot 100 may move along the marker along a direction of an arrow.

In reference numeral 62, an obstacle is disposed on the marker 300. As the obstacle is disposed on the marker 300, the cart-robot 100 may wait until the obstacle moves. However, when the waiting time becomes longer, use efficiency of the cart-robot 100 is lowered and the cart-robot 100 may be discharged. Thus, as shown in reference numeral 63, the cart-robot 100 generates a bypass path based on markers disconnected due to the obstacle and moves while avoiding the obstacle and returns back to the marker 300.

As shown in FIG. 11, when the obstacles are disposed on markers having a straight-line shape, the cart-robot 100 maintains movement in a straight direction and may generate the bypass path to avoid the obstacle, around the obstacle, and may return back to the marker 300 after deviating from the marker 300 by a short distance.

As shown in FIG. 12, reference numeral 66 shows that a curved marker 300 is disposed. As shown in reference numeral 66, based on the obstacle being not present, the cart-robot 100 may move along the marker in a direction of an arrow.

Reference numeral 67 shows an obstacle disposed on the marker 300. As the obstacle is disposed on the marker 300, the cart-robot 100 may wait until the obstacle moves. However, if the waiting time is long, the use efficiency of the cart-robot 100 may be lowered and the cart-robot 100 may be discharged. Accordingly, as shown in reference numeral 68, the cart-robot 100 generates a bypass path based on the markers disconnected due to the obstacle and moves while avoiding the obstacle to return back to the marker 300.

As shown in FIG. 12, when the obstacle is disposed on the marker having a shape with a right angle, the cart-robot 100 may maintain the movement in a rightward direction, in a shape having the right angle. The bypass path is generated around the obstacle to avoid the obstacle so that the cart-robot 100 deviates from the marker 300 by a short distance and returns back to the marker 300.

As shown in examples in FIGS. 11 and 12, when the obstacle sensor 220 detects an obstacle in a moving direction of the cart-robot 100, the controller 250 may temporarily stop the cart-robot 100 (in reference numerals 62 and 67). Alternatively, the controller 250 may move the cart-robot by generating a bypass path to connect two markers disconnected by the obstacle (in reference numerals 63, 68).

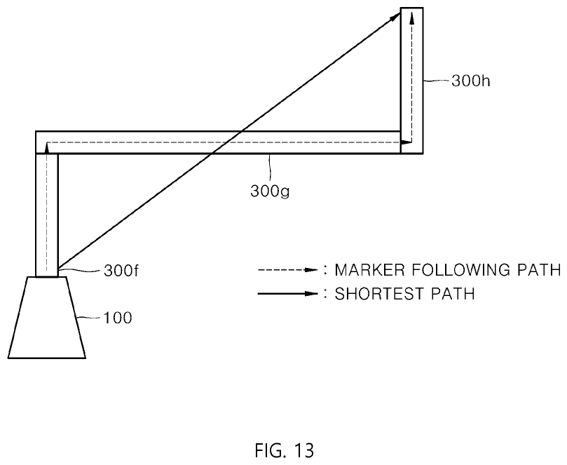

FIG. 13 shows an exemplary process in which a cart-robot generates a shortest path based on markers.

A cart-robot 100 moves along three markers 300f, 300g, and 300h disposed in front of the cart-robot 100. However, when there are no obstacles or other cart-robots around these markers, the cart-robot 100 may not move along the markers, but straightly move to a marker 300h disposed at a final point.

That is, as shown in FIG. 13, the cart-robot 100 may move along a shortest path and move to an end point of the marker 300h disposed at the final point. Therefore, based on the obstacle being not present between the marker disposed finally and the current robot, among markers disposed along a moving path in a space where a plurality of markers are disposed, or during generation of the bypass path due to the obstacle, the controller 250 may set the shortest path and may move along the shortest path.

FIG. 14 shows an exemplary configuration of a marker. A marker 300 includes one or more light sources 300. The light sources 300 emit light. A marker controller 350 controls light emission of each of light sources. The marker controller 350 controls the color of light emitted by each of light sources, an on-state/an off-state of the light source, a flickering speed, and the like.

When a plurality of light sources are included in one marker 300, the color, on-state/off-state, the flickering speed, and the like, of each of light sources may be included in information. When the camera sensor 260 of the cart-robot 100 photographs the marker, the controller 250 controls the movement of the cart-robot 100 based on the information on the color, the shape, and the flickering of the marker.

The communicator 340 receives, from a server 400, a control message to control the operation of the marker. Alternatively, the communicator 340 may receive a result of moving from the cart-robot 100.

The obstacle sensor 320 detects that an obstacle is disposed on or around the marker. For example, when the marker is disposed on the travelling surface, the obstacle sensor 320 includes a weight sensor or an ultrasonic sensor to sense that an obstacle is disposed around the marker. Alternatively, when the marker is disposed on the side surface or the ceiling, the obstacle sensor 320 includes the ultrasonic sensor or the infrared sensor to sense that the obstacle is disposed in the movement path generated along the marker.

When the obstacle sensor detects the obstacle, the marker controller 350 may control the light emission color, the flickering pattern, or the on-state/off-state of the light source 330.

Further, the communicator 340 of the marker 300 may repeatedly output identification information of the marker. The cart-robot 100 may identify identification information of the markers and may transmit, to the server 300, information on a current position of the cart-robot 100. For example, the cart-robot 100 transmits, to the server 400, identification information of the marker, a identified time point, and movement information, for example, a moving distance or a moving direction after the identification. The server 400 may monitor the moving state of the cart-robots based on the collected information.

As shown in FIG. 14, a marker may be disposed on the floor or the side surface or the ceiling of the travelling surface and may have various types of shapes, for example, a line form, a dotted form, and an arrow form.

Meanwhile, in order to determine whether to include or exclude a particular marker in the path during generating of a path based on the marker, each of sensors may acquire information and store the information. The stored information may be learned using an artificial intelligence module to repeatedly generate an optimized path.

To this end, the artificial intelligence included in the controller 250 is a kind of learning processor and may generate a final moving path based on position information related to markers accumulatively stored by the robot 100, information sensed by the sensor, and a numerical value with respect to a degree contributed to generate, by the markers, the path.

When the above-described embodiments are implemented, the user may not be required to return the cart-robot to a particular point when the cart-robot moves from the mart to the parking lot and the use of the cart-robot is finished. Further, the cart-robot automatically moves to the particular position (e.g., the storage station or the charging station) along the marker without additionally taking back the cart-robot to move, thereby improving the user convenience. In particular, the marker may be disposed so that the cart-robot 100 automatically returns to the charging station. In this case, the cart-robot 100 may be automatically charged

Further, the markers may have different colors so that the cart-robot 100 may easily distinguish the spaces. Further, as frictional forces may vary based on material of the floor of the mark and the parking lot, the controller of the cart-robot 100 provides a current compensation of the motor applied to the mover based on a magnitude of the frictional force or properties of the space where the marker is disposed, so that the cart-robot may travel.

In one embodiment, based on markers sensed by the cart-robot 100 having green color, the marker having the green color is determined as a marker disposed in the store. Further, based on the color of the markers detected by the cart-robot 100 being orange color, the marker having the orange color is determined as a marker disposed in the parking lot.

The controller 250 may perform the current compensation with respect to the motor to be suitable for the store or for the parking lot based on the colors of the markers.

The term “AI” refers to machine intelligence or a field of researching a methodology of making the AI. The term “machine learning” refers to a field of researching a methodology of defining and solving various problems dealt in an AI field. The machine learning is also defined as an algorithm to improve performance of any operation through steady experience.

An artificial neural network (ANN) is a model used in the machine learning. The ANN may include artificial neurons (nodes) that form a network by coupling synapses and may refer to an overall model having an ability to solve problems. The ANN may be defined through a connection pattern between neurons of different layers, a learning process of updating model parameters, and an activation function for generating an output value.

The ANN may include an input layer and an output layer and may optionally include one or more hidden layers. Each layer may include one or more neurons, and the ANN may include a synapse that connects the neurons. In the ANN, each neuron may output input signals input through the synapse, weightings, and function values of an activation function with respect to deflection.

The term “model parameter” refers to a parameter determined through learning and includes a weighting of synaptic connection and deflection of neurons. The term “hyperparameter” refers to a parameter that should be set in a machine learning algorithm before learning and includes a learning rate, a repetition number, a mini-batch size, and an initialization function.

A learning purpose of learning of the ANN may be considered to determine model parameters to minimize a loss function. The loss function may be used as an index for determining optimal model parameters in a learning process of the ANN.

The machine learning may be classified into supervised learning, unsupervised learning, and reinforcement learning according to a learning method.

The term “supervised learning” may refer to a method of training the ANN when a label with respect to learning data is given. The term “label” may refer to a right answer (or a result value) that should be deduced by the ANN when the learning data is input to the ANN. The term “unsupervised learning” may refer to a method of training the ANN when a label is not given with respect to learning data. The term “reinforcement learning” may refer to a learning method of training an agent defined in any environment so as to take an action of maximizing a cumulative reward in each state or select order of actions.

Machine learning implemented through a deep neural network (DNN) including a plurality of hidden layers among ANNs is also referred to as “deep learning”. The deep learning is a portion of the machine learning. Hereinafter, the term “machine learning” is used to include the meaning of the term “deep learning.”

In the robot 100, the above-described AI module, which is a sub-component of the controller 250, may perform an AI function. The AI module in the controller 250 may include software or hardware.

In this case, the communicator 280 of the robot 100 may transmit and receive data to and from external devices such as a robot which provides another AI function and an AI server 700 described with reference to FIG. 15 using wired or wireless communication technology. For example, the communicator 280 may transmit and receive sensor information, user input, a learning model, and a control signal to and from the external devices.

In this case, the communication technology used by the communicator 280 may include global system for mobile communication (GSM), code division multiple access (CDMA), long term evolution (LTE), fifth generation (5G) wireless communication, a wireless local area network (WLAN), Wi-Fi, Bluetooth, radio frequency identification (RFID), infrared data association (IrDA), ZigBee, and near field communication (NFC).

The interface 230 may acquire a variety of data.

In this case, the interface 230 may include a camera that inputs a video signal, a microphone that receives an audio signal, and a user inputter that receives information from a user. Here, pieces of information acquired by the obstacle sensor 220, the camera sensor 260, or the microphone refer to sensing data, sensor information, and the like.

The interface 230 and various types of sensors 220 and 260 and wheel encoders of the movement unit 190 may acquire input date and the like to be used when output is obtained using a learning model and learning data for the learning model. The above-described components may acquire raw input data. In this case, the controller 250 or the AI module may extract input features by preprocessing the input data.

The AI module may train a model including ANNs using learning data. Here, a trained ANN may be referred to as “a learning model”. The learning model may be used to deduce a result value with respect to new input data rather than learning data, and the deduced value may be used as a basis for determining whether the robot 100 performs any action.

In this case, the AI module may perform AI processing together with a learning processor 740 of the AI server 700.

Here, the AI module may be integrated within the robot 100 or may include an implemented memory. Alternatively, the AI module may be implemented using an additional memory, an external memory coupled to the robot 100, or a memory maintained in an external device.

The robot 100 may acquire at least one of internal information related to the robot 100, surrounding environment information related to the robot 100, and user information using various types of sensors.

In this case, the sensors included in the robot 100 include a proximity sensor, an illuminance sensor, an acceleration sensor, a magnetic sensor, a gyro sensor, an inertial sensor, an RGB sensor, an infrared ray (IR) sensor, a fingerprint recognition sensor, an ultrasonic sensor, an optical sensor, a microphone, a LiDAR sensor, the obstacle sensor 220, the camera sensor 260, and a radar.

In addition, the above-described interface 230 may generate output related to visual, acoustic, or tactile senses.

In this case, the interface 230 may include a display configured to output visual information, a speaker configured to output auditory information, and a haptic module configured to output tactile information.

A memory embedded in the robot 100 may store data for supporting various types of functions of the robot 100. For example, the memory may store input data, learning data, a learning model, a learning history, and the like acquired by various types of sensors embedded in the robot 100, the interface 230, and the like.

The controller 250 may determine one or more executable operations of the robot 100 based on information determined or generated using a data analysis algorithm or a machine learning algorithm. The controller 250 may control the components of the robot 100 to perform the determined operations.

To this end, the controller 250 may request, search for, receive, or use data in the AI module or the memory and may control the components of the robot 100 to perform an operation being estimated or an operation being determined to be desirable among the one or more executable operations.

In this case, when an external device is required to be connected to perform the determined operations, the controller 250 may generate a control signal for controlling the external device and may transmit the generated control signal to the external device.

The controller 250 may acquire intention information corresponding to user input and may determine requirements of a user based on the acquired intention information.

In this case, the controller 250 may acquire the intention information corresponding to the user input using at least one of a speech-to-text (STT) engine for converting voice input into a string or a natural language processing (NLP) engine for acquiring intention information related to a natural language.

In this case, at least a portion of at least one of the STT engine or the NLP engine may include an ANN trained according to a machine learning algorithm. At least one of the STT engine and the NLP engine may be trained by the AI module, or the learning processor 740 of the AI server 700, or by distributed processing thereof.

The controller 250 may collect history information including operations of the robot 100 and user feedback on the operations and may store the collected history information in the memory or the AI module or transmit the collected history information to an external device such as the AI server 700. The collected history information may be used to update a learning model.

The controller 250 may control at least some of the components of the robot 100 to execute an application program stored in the memory 170. Furthermore, the controller 250 may combine and operate at least two of the components included in the robot 100 to execute the application program.

Alternatively, an additional AI server communicating with the robot 100 may be provided and may process information provided by the robot 100.

FIG. 15 shows an exemplary configuration of an AI server.

The term “AI server,” that is, the AI server 700, may train an ANN using a machine learning algorithm or use the trained ANN. Here, the AI server 700 may include a plurality of servers to perform distributed processing or may be defined as a 5G network. In this case, the AI server 700 may be included as a portion of the AI device such as robot 100 and may perform at least a portion of the AI processing together.

The AI server 700 may include a communicator 710, a memory 730, the learning processor 740, a processor 760, and the like.

The communicator 710 may transmit and receive data to and from an external device such as the robot 100 or the like.

The memory 730 may include a model storage 731. The model storage 731 may store a model (or an ANN 731a) which is being trained or is trained through the learning processor 740.

The learning processor 740 may train the ANN 731a using learning data. A learning model may be used in a state of being mounted in the AI server 700 of an ANN or may be used by being mounted in an external device such as the robot 100 or the like.

The learning model may be implemented in hardware, software, or a combination of hardware and software. When a portion or all of the learning model is implemented in software, one or more instructions that constitute the learning model may be stored in the memory 730.

The processor 760 may deduce a result value with respect to new input data using the learning model and generate a response or a control command based on the deduced result value.

Although components configuring the embodiments of the present disclosure have been described to be combined as one unit or to operate as a combination thereof, the present disclosure is not necessarily limited to the embodiments. That is, within the scope of the present disclosure, these components may be selectively combined into one or more thereof to operate in combination. In addition, although each of the components may be implemented as independent hardware, some or all of the components may be selectively combined with each other and implemented as a computer program having program modules for executing some or all of the functions combined in one or more pieces of hardware. Codes and code segments forming the computer program can be easily conceived by an ordinarily skilled person in the technical field of the present disclosure. Such a computer program may implement the embodiments of the present disclosure by being stored in a computer readable storage medium and being read and executed by a computer. A magnetic recording medium, an optical recording medium, a semiconductor recording element, or the like may be employed as a storage medium of the computer program. In addition, a computer program embodying the embodiments of the present disclosure includes a program module that is transmitted in real time through an external device.

As described above, although the embodiments of the present disclosure have been mainly described, various alterations or modifications may be made by persons having ordinary skills in the art. Therefore, such alterations and modifications can be said to belong to the present disclosure as long as they do not depart from the scope of the present disclosure.

1. A cart-robot of moving in a marker following mode, the cart-robot comprising:
a mover configured to move the cart-robot and to comprise at least one wheel;
an obstacle sensor configured to sense an obstacle disposed around the cart-robot;
a camera sensor configured to photograph a marker disposed on a traveling surface of the cart-robot or on a side surface of the traveling surface or on the ceiling of the traveling surface; and
a controller configured to analyze an image photographed by the camera sensor and calculates a moving direction or a moving speed of the cart-robot that moves along the marker or a path where a plurality of markers are disposed and controls the mover to move the cart-robot into a space indicated by the marker.

2. The cart-robot of moving in the marker following mode of claim 1,
wherein the controller determines a state in which an object is removed from a storage of the cart-robot or a state in which use of a transmitter followed by the cart-robot is finished or a handle assembly of the cart-robot may not sense a force for a predetermined period of time,
wherein the controller controls the camera sensor and the mover to search for the marker adjacent to the cart-robot, and
wherein the controller controls the mover to move the cart-robot along the marker adjacent to the cart-robot.

3. The cart-robot of moving in the marker following mode of claim 2, wherein the controller determines that the cart-robot enters a parking lot based on changes in vibration generated based on friction between the mover and the travelling surface or frictional forces with respect to the travelling surface, applied to the mover.

4. The cart-robot of moving in the marker following mode of claim 1, wherein, when the obstacle sensor detects an obstacle in a moving direction of the cart-robot, the controller stops the cart-robot or the controller generates a bypass path to connect two markers disconnected due to the obstacle and moves the cart-robot.

5. The cart-robot of moving in the marker following mode of claim 1,
wherein the controller monitors a charging state of the cart-robot and searches for a marker indicating movement to a charging station using the camera sensor, and
wherein the controller moves the cart-robot along the found markers.

6. The cart-robot of moving in the marker following mode of claim 5, wherein, when the camera sensor photographs a standby marker during moving along the marker, the controller stops the movement of the cart-robot, and subsequently, searches for other cart-robots being charged in the charging station or an obstacle disposed around the charging station, using the obstacle sensor or the camera sensor.

7. The cart-robot of moving in the marker following mode of claim 1,
wherein the marker comprises one or more light sources that emit light, and
wherein the controller calculates the moving speed or the moving direction of the cart-robot in a space where the marker is disposed based on any one of the color, a shape, or a flickering pattern of the marker.

8. The cart-robot of moving in the marker following mode of claim 1,
wherein the marker comprises one or more light sources that emit light;
a communicator configured to receive a control message from the server to control operation of the marker; and
a marker controller configured to control light emission of each of the light sources in response to the control message.

9. The cart-robot of moving in the marker following mode of claim 8, wherein the marker further comprising an obstacle sensor configured to detect that an obstacle is disposed on the marker or in an area in which the marker is disposed,
wherein the marker controller controls, based on the obstacle sensor detecting the obstacle, a color emitted by the light source or a flickering pattern or an on-state/off-state of the light source.

10. A method for moving a cart-robot in a marker following mode, comprising:
moving, by at least one wheel of a mover of the cart-robot, the cart-robot;
photographing, by a camera sensor of the cart-robot, a marker disposed on a travelling surface of the cart-robot, a side surface of the travelling surface, or the ceiling of the travelling surface during moving of the cart-robot;
analyzing an image photographed by the camera sensor and identifying, by a controller of the cart-robot, the marker;
calculating, by the controller of the cart-robot, a moving direction or a moving speed of the cart-robot that moves along the identified marker or a path where the plurality of markers are disposed; and
controlling, by the controller, the mover to move the cart-robot into a space indicated by the marker based on at least one of the calculated moving direction or moving speed of the cart-robot.

11. The method for moving the cart-robot in the marker following mode of claim 10, comprising:
determining, by the controller, a state in which an object is removed from a storage of the cart-robot or a state in which use of a transmitter followed by the cart-robot is finished or a handle assembly of the cart-robot may not sense a force during a predetermined period of time;
controlling, by the controller, the camera sensor and the mover to search for the marker adjacent to the cart-robot; and
controlling, by the controller, the mover to move the cart-robot along the marker adjacent to the cart-robot.

12. The method for moving the cart-robot in the marker following mode of claim 11, further comprising determining that the cart-robot enters a parking lot based on changes in vibration occurring due to a friction between the mover and the travelling surface or a frictional force of the travelling surface, applied to the mover.

13. The method for moving the cart-robot in the marker following mode of claim 10, further comprising:
detecting, by the obstacle sensor, an obstacle in the moving direction of the cart-robot; and
stopping, by the controller, the cart-robot or generating, by the controller, a bypass path to connect two markers disconnected due to the obstacle to move the cart-robot.

14. The method for moving the cart-robot in the marker following mode of claim 10, comprising:
monitoring, by the controller, a charging state of the cart-robot and searching for a marker indicating movement of a charging station using the camera sensor; and
moving, by the controller, the cart-robot along the found markers.

15. The method for moving the cart-robot in the marker following mode of claim 14, comprising:
photographing, by the camera sensor, a standby marker during moving along the marker;
stopping, by the controller, the movement of the cart-robot; and
searching, by the controller, other cart-robots being charged at the charging station or an obstacle disposed around the charging station using the obstacle sensor or the camera sensor.

16. The method for moving the cart-robot in the marker following mode of claim 10,
wherein the marker comprises one or more light sources that emit light, and the method comprising calculating a moving speed or the moving direction of the cart-robot in a space where the marker is disposed based on at least one of the color or a shape or a flickering pattern of the marker.

17. The method for moving the cart-robot in the marker following mode, comprising:
generating, by a server, a marker control message by monitoring arrangement states of a plurality of cart-robots and obstacles;
transmitting, by the server, the marker control message to the marker;
activating or deactivating, by the marker, a light source of the marker in response to the marker control message;
moving the cart-robot that moves while following the marker by determining the activation state or the deactivation state of the marker.

18. The method for moving the cart-robot in the marker following mode of claim 17, wherein the marker control message is used to control an on-state or an off-state of one or more light sources included in the marker.

19. The method for moving the cart-robot in the marker following mode of claim 17, comprising:
repeatedly outputting, by the marker, identification information; and
identifying, by the cart-robot, the output identification information and transmitting, to the server, the identification information and the movement information related to the cart-robot.

20. The method for moving the cart-robot in the marker following mode of claim 17, comprising:
detecting, by an obstacle sensor of the marker, an obstacle disposed on the marker or in an area in which the marker is disposed;
controlling, by a marker controller of the marker, a color emitted by the light source or a flickering pattern or an on-state/off-state of a light source of the marker, based on the obstacle sensor detecting the obstacle.
